(19) United States
(12) Patent Application Publication
(10) Pub. No.: US 2015/0292279 A1
(43) Pub. Date: Oct. 15, 2015

(54) Method of Stopping Lost Circulation

(71) Applicant: Sharp-Rock Technologies, Inc., Cypress, TX (US)

(72) Inventor: Hong Wang, Cypress, TX (US)

(73) Assignee: Sharp-Rock Technologies, Inc., Cypress, TX (US)

(21) Appl. No.: 14/541,613

(22) Filed: Nov. 14, 2014

Related U.S. Application Data
(63) Continuation-in-part of application No. 14/248,428, filed on Apr. 9, 2014.

(51) Int. Cl. E21B 21/00; C09K 8/50; E21B 21/14

(52) U.S. Cl. CPC E21B 21/003; E21B 21/14; C09K 8/50

(57) ABSTRACT

A method for forming a seal to subterranean fractures or other voids penetrated by a wellbore comprises a particulate sealing formulation of fast sealing and/or fast strengthening. To achieve fast sealing, the particulate formulation is comprised of multiple groups of particulates of a narrow particle size distribution. Furthermore, the method comprises minimizing the spurt loss of a formulation by adjusting its particulates larger than D30, based on evaluation with a slot disk test method. The fast strengthening of the formulation is achieved by fast accumulation of particulates. Furthermore, the method comprises maximizing the fluid loss after spurt of a formulation by adjusting its particulates smaller than D30 or adding some diatomaceous earth or selecting particulates of a D75 larger than 75 microns and with a narrow particle size distribution. At least 5% of the sealing particulates by weight of the total particulates are smaller than 200 micron and acid soluble.

### RELATED APPLICATIONS

This disclosure constitutes a continuation in part of application Ser. No. 14/248,428 filed Apr. 9, 2014, entitled “A Method of Stopping Lost Circulation”.

### FIELD OF USE

The disclosure pertains to formulating and manufacturing a mixture of particulates to be added to fluids to quickly seal fractures or other types of mud loss flow paths in formations connected to a wellbore in order to stop lost circulation. The disclosure includes methods for optimizing a formulation of sealing particulates and a method of applying such a formulation to stop lost circulation.

### BACKGROUND OF INVENTION

Hydrocarbon exploration and extraction requires drilling wells in subterranean formations. Drilling normally requires a drill bit connected to the end of a drill string. The drill string comprises a hollow drill pipe for providing rotational torque to rotate the drill bit for boring the rock. Boring of the rock forms a wellbore. The hollow drill pipe of the drill string also delivers drilling fluid through the drill pipe to the drill bit to cool the bit, lubricate the bit, carry the drilled cuttings to the surface, etc.

Drilling fluid or drilling mud normally is contained in tanks at the surface and pumped into the drill pipe by a mud pump. It then flows through the hollow drill pipe downward to the bit and exits the drill bit through nozzles on the bit into the annulus between a wellbore (formed by the bit) and the drill pipe. Through the annulus, the drilling fluid travels upward to the surface carrying the drilled cuttings back to the surface. At the surface there are solid control systems including shale shakers that can separate the drilled cuttings from the drilling fluid. The drilling fluid can be pumped back into drill pipe to the bit. Normally drilling fluid is circulated in such a drilling process.

During a normal drilling process, the drilled hole or wellbore is full of drilling fluid. The drilling fluid also provides necessary hydrostatic wellbore pressure to balance the formation fluid pressure from either oil, gas or water. When the hydrostatic wellbore pressure from the drilling fluid is smaller than the formation fluid pressure, the oil, gas or water may flow into the well causing blowouts or flow without control. Furthermore the drilling fluid also provides necessary hydrostatic pressure to balance the formation rock stress around the wellbore. When the hydrostatic pressure is too low, the formation rock stress can collapse the wellbore.

Hydrostatic pressure to the wellbore formation from drilling fluid is determined by the density of the drilling fluid and the vertical length of the drilling fluid column above the formation depth or the vertical depth of the well when the well is full of the drilling fluid. Higher density of the drilling fluid can apply higher pressure to the wellbore at the same vertical depth. The higher density is achieved by adding weighting materials or high density insoluble powder to drilling fluid. These weighting materials include barite which has a specific gravity of 4.2. Weighting materials for the majority of its particles normally have a size ranging from 20 to 75 microns.

Furthermore, additional wellbore pressure can also come from drilling fluid circulation. During circulation, fluid flows upward in the annulus creating friction pressure acting on the wellbore. So the total wellbore pressure is normally higher when a well is in circulation of drilling fluid.

However, the wellbore pressure is not allowed to be too high either. A too high wellbore pressure can inflate the wellbore and eventually break the wellbore down and create a fracture within the wellbore. The fracture generated by excessive wellbore pressure during drilling is called an induced fracture. After an induced fracture is generated, drilling mud may continue to be lost into the fracture and only some or no mud will return to the surface. This loss of drilling mud is called lost returns or lost circulation. This also can be simply called losing mud or mud losses.

There are also natural voids in the subterranean formations. These voids may include large pores, vugs (small cavities), caverns, natural fractures, etc. Lost circulation may happen when these voids are penetrated by a wellbore during drilling and exposing the voids to the drilling mud.

When particles pack together to form a structure, there are interstitial spaces between the particles in the structure. These spaces are called pores. Pores may be connected to one another and the narrowest space between two neighboring pores is called a pore throat. In general, larger particles together form larger pores and pore throats.

Induced fractures, large pores, vugs, caverns, and natural fractures are the paths for losing mud into and are sometimes called mud loss flow paths. A wellbore interval containing such mud loss flow paths can be referred as a lost circulation zone or a loss zone.

When lost circulation happens, the wellbore may not be able to maintain a certain level of the drilling fluid and wellbore pressure. Blowouts or wellbore collapse may occur. These problems can be very time consuming and expensive to repair. When no drilling fluid is returning to the surface, continuous drilling may cause drilled cuttings to accumulate in the wellbore and the drillpipe may become stuck. Furthermore, drilling fluid can be very expensive. Therefore, it is beneficial to stop losing drilling fluid into formations in order that all drilling fluid returns to the surface for further drilling operations. When lost circulation is stopped, the wellbore losing drilling fluid is cured.

Drilling fluid or drilling mud normally contains clay in a water based mud or organoclay in an oil based mud. These clay particles may range from 0.5 micron to 2 micron. Due to the clay and other additives, drilling mud is normally capable of sealing tiny pores of rock formations as large as several microns as in a regular sandstone formation by filtration. The clay can easily form a thin filter cake, called mud cake, on the surface of permeable rock. The mud cake allows only the filtrate or solid free liquid to slowly flow into the formation. The filtrate, normally a liquid, is referred to as fluid loss in the drilling industry. It is desirable to form a thin mud cake from regular mud by tightly controlling a very low fluid loss with fluid loss control additives. When a fluid loss control additive added to mud, it is expected that the fluid loss is substantially lowered.

Sometimes, other than the clay particles in mud, drilling mud may also contain other particles including weighting materials such as barite particles or fine cuttings that may be larger than clay. Mud containing typical commercial barite may have an average size of 45 microns and can seal pores of up to approximately 150 microns.

Losing drilling mud into formations such as fractures is different from fluid loss of drilling mud. Losing drilling mud is losing the whole drilling fluid (liquid and solid particles) and it is often called mud loss. In contrast, fluid loss is referred to as losing only the liquid portion of mud by filtration against a permeable rock formation surface. No solids flow into the formation when a mud cake has been formed.

The fluid loss behavior of a drilling fluid can be tested with lab apparatus. According to API (American Petroleum Institute) Recommend Practice (RP) 13I (Seventh Edition, February 2004), and which is incorporated in its entirety by reference herein, a conventional test to determine the capability of sealing pores is done by utilizing the Permeability Plugging Apparatus (PPA) against porous ceramic disks with small pores or filter paper as a test medium simulating the wellbore rock surface. Additionally, there are low pressure/low temperature (LP/LT) tests and high temperature/high pressure (HT/HP) tests. In the conventional tests, typically there is a spurt loss volume, Vₛₚ, at the beginning of the test when pressure is initially applied to the test cell. The spurt loss volume is the amount of fluid that passes through the filtration medium before an initial filter cake or a first particle layer is formed. This cake is the mud cake for drilling mud or drilling fluid. Typically, the spurt loss fluid contains some fine solid particles from the test fluid that pass through the pores of the filtration medium before the first particle layer is just formed and, therefore, the spurt fluid is often turbid.

In the aforementioned tests, after the spurt loss and the initial formation of a filter cake, a steady filtration fluid loss process starts. In the steady filtration fluid loss period, because of the filter cake or mud cake, only filtrate can flow through as the fluid loss. At the same time, more particles suspended in the test fluid deposit on the filter cake and cause the filter cake to thicken. In this period, the particle layer has much smaller pores and all solids are basically blocked and the fluid collected is normally a particle-free clear liquid. The fluid loss generally reported is the cumulative fluid loss at 30 minutes or V₃₀ as an API standard. The fluid loss, V₃₀, therefore includes the spurt loss volume, Vₛₚ. The fluid loss after spurt can be defined as V₃₀ less Vₛₚ. The fluid loss after spurt indicates how fast the liquid can flow through the formed mud cake in the test cell. This behavior can also be observed when a filter paper rather than a porous ceramic disk is used as the filtration medium as described in API Recommended Practice 13B which is also incorporated by reference herein in its entirety.

A plot of a cumulative fluid loss during the test against the square root of filtration time t will typically resemble the plot illustrated in FIG. 1. As shown by the solid Line 1 in FIG. 1, during the spurt loss period, the plot is a curved line and during the steady filtration fluid loss period, the plot is substantially a straight line. API Recommended Practices 13I and 13B state that the spurt loss volume can be determined by the intercept on the cumulative fluid loss at filtration time t=0 by extrapolating the straight filtration line back to filtration time t=0. The end of the spurt loss period tₛₚ may be visually judged as the filtration time t corresponding to the starting point of the straight line. It can also be judged by observing the fluid loss fluid flowing out of a test cell when the fluid starts to be transparent or solid free. The spurt loss period may last only several seconds starting from the beginning of a test when pressure is applied to the test cell.

The porous ceramic disks having pore sizes of 10, 20, 40, 50, 120, 150 and 190 micron are commercially available.

However, mud loss flow paths generally are much larger than 150 microns. For example, the width of a fracture may be much wider even than 500 microns (0.020 inches). Sometimes a fracture can be wider than half an inch (12,700 microns). Even with barite weighted mud (having a size ranging from 20 to 75 microns), lost circulation happens frequently during drilling. The particles normally existing in drilling mud often are not large enough to seal a mud loss flow path such as a fracture.

To stop losing mud, it is necessary to seal these mud loss flow paths with some sealing formulations. A typical sealing formulation is of particulates with a wide particle size distribution. The particulates are often mixed in a certain volume of fluid to form a lost circulation material (LCM) slurry pill to be pumped down to the lost circulation zone in order to seal the mud loss flow paths. Such a pill may be around 100 barrels. However, the wellbore may contain 1000 to 5000 barrel of drilling fluid and the pill may have to be displaced by drilling fluid to a depth of 20,000 ft downhole. When the pill is flowing into a mud loss flow path at a loss zone, the particulates may accumulate at the entrance of or at a flow restriction inside a mud loss flow path, such as a fracture, to form a seal. When all mud loss flow paths are sealed off, lost circulation is cured.

Particle size distribution is often displayed as shown in FIG. 2 as a fractional distribution plot in which particle sizes can be designated with Dnn where the subscript ‘nn’ is the percentage by volume of particles with sizes less than Dnn. The values most frequently measured in this form are D10, D50, and D90 which give an indication of the size of the fine (D10), coarse (D90), and the median (D50) particles. For example, D50=650 micron means that the median particle size of the particle formulation is 650 microns. In other words, 50% by volume of the particles are smaller than 650 microns. D90=1250 micron means that 90% by volume of the particles are less than 1250 microns. If D50=650 micron, 0.5 times of D50 is 325 micron and 1.5 times of D50 is 975 micron. If all particles or a percentage of the particles such as 70% fall into a range from 0.5 times of its D50 to 1.5 times of its D50 and the D50 is 650 micron, it means that all particles or the percentage of the particles fall in between 325 micron and 975 micron. This can be referred to as a size group. This can be used to show how wide the particle size distribution is. When the particle size distribution is narrow or small, the particles have similar sizes. When the particle size distribution (size group) is wide or large, the particles have many different sizes. When some particles are packed up together at the entrance of a fracture forming a seal and shutting off fluid flow, it is difficult to let more particles to accumulate onto the formed seal and the seal may be very weak and not strong enough for the drilling conditions.

In order to form a strong seal, a high fluid loss particulate formulation has been used in order to achieve a thick or strong seal. This formulation is typically mixed in water or oil and is of a high fluid loss. With such as a formulation, a formed seal is still highly permeable to the mixing water or oil. Over time, due to the fact that the mixing water or oil is still flowing through the initially formed seal, more of the same particles will continue to deposit onto the seal to keep growing the seal in its thickness. The seal therefore can get stronger over time. In order to speed up the seal growing process, a special filtration enhancing material is always added to enhance the fluid loss through the formed seal by improving the permeability of the formed seal to the mixing water or oil. This special material is diatomaceous earth powder. The particles of diatomaceous earth have many tiny holes or pores and normally make the formed seal highly permeable to the mixing water or oil. However, the pores are so small and they are plugged by clay particles in drilling fluid and the seal therefore is still impermeable to normal drilling fluid. After the seal has formed, during drilling, drilling mud that cannot pass through the seal naturally form a mud cake on the seal to eventually stop lost circulation.

However, an open wellbore always contains drill mud, which is normally a low fluid loss fluid. A high fluid loss lost circulation material pill is typically not compatible with mud. When such a high fluid loss lost circulation material pill is pumped into a wellbore, contamination or mixing with mud is often experienced. When such a high fluid loss lost circulation material slurry is contaminated by mud, the natural fluid loss control materials such as clay and fluid loss additives in the mud will plug the pores of the diatomaceous earth and then the needed high fluid loss property for the pill is lost. Without the needed high fluid loss property, such lost circulation material slurry can no longer form a thick and strong seal to stop lost circulation any more.

During drilling operations, when lost circulation is encountered, it is often experienced that an LCM (lost circulation material) pill either does not form a seal or the seal is not strong enough. Due to the complexity of the subterranean geological conditions, lost circulation frequently happens during drilling and conventional LCM methods often fail to cure the losses, costing the industry billions of dollars each year. Therefore people are still looking for better and more reliable LCM and methods to cope with this drilling challenge. This invention provides a new method for making a formulation of particulates to be mixed with fluid and a method to apply such a formulation to stop lost circulation.

### SUMMARY OF THE INVENTION

The applicant's disclosure teaches a method for stopping lost circulation of drilling fluid in a wellbore. The method comprises formulating a particulate sealing formulation to achieve fast formation of a seal and/or fast strengthening of an initially formed seal. To achieve fast sealing, the particulate formulation comprises particulates of a wide particle size distribution. Furthermore, such a formulation comprises multiple groups of particulates of similar sizes in a specific ratio. The formulation is further optimized by adjusting the ratio of groups of particulates larger than D30 for fast sealing by evaluating its spurt loss in a carrying fluid against a slot disk with slots simulating the entrance of a fracture along a wellbore.

Furthermore, the sealing formulation can achieve fast strengthening of its initially formed seal. The fast strengthening of a formed seal from a sealing formulation is achieved by a controlled leakage through the initially formed seal structure. The leakage can allow further fast accumulation of more particulates on to the formed seal structure. To achieve fast seal strengthening, the fluid loss after spurt is evaluated according to an API method. The formulation is then adjusted by changing the particles that are smaller than D30 toward a more uniform size. Furthermore, the fast seal strengthening is achieved by the forming seal further comprising particles that have holes in the bodies of the particles. These holes allow liquid to easily pass through the particles. An example of such particles is diatomaceous earth powder. Even further, the fast strengthening can be also promoted by increasing the fluid loss of the carrying fluid by either diluting the carrying fluid with its base liquid or removing at least some of its fine particles contained in regular drilling fluid. When the fast strengthening particulate formulation is intended to be used in regular drilling fluid containing clay and weighting materials, 80% of the particulates should have a particle size above 150 microns and preferably the particulates have a narrow particle size distribution.

Flexible bridging materials including sponge, magnetic sponge, foam rubber, open cell foam rubber, fiber, shredded rag, paper, straw, cotton, fiber pads, entangled fiber can be further included in the formulation. The inventor's pending patent application Ser. No. 14/225,346 filed Mar. 25, 2014 entitled “Method of Sweeping Solids or Displacing a Fluid in a Wellbore” is incorporated herein by reference in its entirety.

The particulate formulation can be either mixed in a blender in a factory or at a rig site of drilling. The particulates eventually are mixed with a carrying fluid in a tank before use to form a particulate sealing fluid. Then the sealing fluid is pumped down hole through drill pipe or tubing to a subterranean loss zone.

The carrying fluid comprises of water, brine, oil, synthetic oil, diesel, polymer solution, sea water, drilling fluid, cement slurry, cement spacer fluid, completion fluid, oil based drilling fluid, water based drilling fluid, synthetic drilling fluid, salt saturated water.

### BRIEF DESCRIPTION OF THE FIGURES

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates typical fluid loss characteristics of an API fluid loss test. It is suitable for testing a sealing fluid with filter paper, porous ceramic disk or slot disk as the filtration medium. In FIG. 1, the solid line (Line 1) represents a cumulative fluid loss volume measured during a test. Typically, when the cumulative fluid loss volume is plotted against the square root of the filtration time, there will be a curved line period and straight line period. The curved line period is the spurt loss period and the straight line period is the steady fluid loss period.

FIG. 2 illustrates a typical particle size distribution, in which D10, D50 or D90 represent the particle sizes below which the total volume of the particles are 10%, 50% or 90% of the total volume of the particles of the entire distribution.

### DETAILS OF THE INVENTION

### I. A Fast Sealing Particulate Formulation

Fractures or similar voids penetrated by a wellbore may have various widths or sizes. It is therefore advantageous for a sealing particulate formulation to have both large and small particulates. In one embodiment of the present invention, a fast sealing particulate formulation comprises a plurality of particulates with a particle size distribution from small to large. In another embodiment, the particle size of a particulate fast sealing formulation is distributed from 0.5 micron to 3000 micron. In one embodiment, the distribution of the particulate fast sealing formulation has a D90 smaller than 1200 micron. In one embodiment, the distribution of the particulate fast sealing formulation has a D90 smaller than 700 micron. In another embodiment, the distribution of the largest particle size is greater than 250 micron in at least one dimension. In another embodiment, D20 of the distribution of the fast sealing particulate formulation is smaller than 250 microns.

Furthermore, for example, in a wellbore with an open fracture, fluid flows from the wellbore into the fracture. The fluid carries rigid particles. When a rigid particle in the fluid cannot pass through a flow restriction such as the entrance of the fracture, the rigid particle is filtered out at the flow restriction. When many of such particles in the fluid are filtered out at the flow restriction, there is an accumulation of the particles. In the accumulation, there are gaps or pores between the rigid particles. Without proper small particulates that can seal the pores of the large ones, the accumulation of the particles may be very porous and highly permeable to the fluid. In this case, the particulates cannot form a seal or pressure isolation. Though over time more particulates may accumulate at the fracture entrance and turn the accumulation into a large pile of particulates inside a wellbore, such a pile can be easily disrupted and removed by moving drill pipe and the little control, if there is any, then is lost. Such an accumulation then is not properly suited or designed for pressure isolation or a seal to a fracture in a wellbore. For a particulate sealing formulation, when the particulates have a wide size distribution and the smallest particles are small enough (such as equivalent to the size of particles in regular drilling fluid), the large pores or gaps of the formed accumulation of particles can be filled with large particles to form small pores and small gaps that can be filled with smaller particles to form smaller gaps or pores and so on. Eventually the accumulation can have gaps small enough and the formed accumulation is impermeable to the whole mud and then becomes a seal to a fracture. Therefore, in one exemplary embodiment, to improve the sealing efficiency, a fast sealing particulate formulation of this disclosure comprises a mixture of multiple groups of particulates and each group comprises particles of a similar size or a narrow size distribution in the following three aspects.

First of all, the narrow size distribution range (e.g., from D30 to D50) can be defined for each size group. Specifically, each group of a narrow (small) size distribution has 70% of the particles of the group ranging from 0.5 to 1.5 times the D50 of the group. For example, if the D50 of a group is 600 micron, 70% of the particulates in this group have a size within 300 to 900 micron.

Secondly, the particle size of each group represented by its D50 must have a relationship to its immediate next group in size. The D50 of each group falls in between 0.4 and 2.1 times of the D50 of its next immediate smaller or larger group. For example, if the D50 of a group is 500 micron, the D50 of its immediate smaller group is no smaller than 200 micron and the D50 of its immediate larger group is no larger than 1050 micron. The D50 of the group of the largest size is preferred to be no more than 3000 micron (0.12 inch) and the D50 of the group of the smallest size is preferred to be no less than 0.1 micron. In a preferred embodiment, the D50 of the group of the largest size is no more than 1200 micron. In another embodiment, the D50 of the group of the smallest size is no less than 3 micron.

Thirdly, each group comprised in the fast sealing particulate formulation has a total particle volume. Each group therefore is such selected that the total particle volume of each group is relative to one another with a volume ratio. The total particle volume of the particulates in each group ranges between 0.3 and 2.7 times of that in its immediate next group. For example, if the total particle volume of a group is 100 ml, the total particle volume of its immediate next group should fall in between 33 and 300 ml.

A formulation then is formulated by blending these groups together. Other particles, especially finer particles, may be also added to the formulation in order to enhance the fluid loss control after the spurt loss period. Then the blended formulation is mixed with a fluid in a tank and is pumped down hole for sealing fractures, etc.

With the needed groups of particulates ready, this formulation can also be formulated at a rig site directly in a mixing tank with fluid. Then the formulation is pumped downhole into the wellbore for sealing fractures, etc.

A fast sealing particulate formulation can be mixed to the entire drilling fluid system so that the wellbore can be drilled with the formulation. In this case, the fractures can be immediately sealed once they are exposed to the drilling fluid during drilling.

A fast sealing particulate formulation can be mixed to a small volume of drilling fluid to be pumped downhole into a wellbore for sealing a loss zone.

A fast sealing formulation can be achieved with one or more of many different types of particulate materials. In one embodiment, the fast sealing particulates selected for the sealing formulation comprise of one or more of the following materials: calcium carbonate, sand, coke, petroleum coke, graphite, resilient graphitic carbon, synthetic graphite, diatomaceous earth, cedar fiber, nut hulls, corn cobs, asphalt, gilsonite, rubber, drilled cuttings, saw dust, mica, wood chips, engineering plastics, fly ash, cotton seed hulls, walnut hulls, pistachio hulls, almond hulls, peanut hulls, cement, clay, bentonite, modified clay, organoclay, limestone, lime, magnesium carbonate, magnesium oxide, cement, concrete, dolomite, marble, sea shell, resin particles, metal particles, ceramic particles, weighting materials such as barite, hematite, iron oxide, ilmenite, and combinations thereof. Optionally, nanotechnology particles, e.g., silica nanoparticles, clay nanoparticles, and the like are used for the compositions. Optionally, chemically treated particles are used for the compositions. The chemically treated particles can include resin coated, surface sticky, surface hydrophobic and surface hydrophilic particles.

It is preferred that a sealing formulation can form a seal fast. The faster the sealing, the higher the sealing efficiency. However, even with the same wide particle size distribution, the sealing efficiency can be different if the particle type, surface properties, particle shapes, particle strength, particle resiliency, particle compressibility, etc. are different. The shape of the particles can be granular, flake and/or fibrous. Particle surface properties such as hydrophobic and hydrophilic properties can also affect the sealing efficiency of the particles. If the particles are hydrophobic, the water repelling characteristics may create a better seal in contrast to hydrophilic properties.

Furthermore, particle sizes and shapes are very difficult to control during the typical random fragmentation process with such as a hammer mill. Each batch of the particulates generated out of the same conditions may vary substantially. A particulate formulation made by adding various fractions of different particulates from different batches or sources according to a ratio often give way different sealing performance. Adjustment of the proportion of different components of the sealing particulate formulation can further improve its fast sealing performance. In order to obtain a reliable and quality formulation and quantify the fast sealing, it is advantageous to further directly evaluate the fast sealing efficiency of a particulate sealing formulation by lab testing. When the sealing efficiency can be evaluated, a sealing formulation can be adjusted for improved performance. A sealing formulation can only be used or evaluated after being mixed in a fluid to form a sealing fluid. A lab test of sealing is used to evaluate a fast sealing formulation. The test is to flow a sealing fluid through a disk with slots simulating the entrance of fractures. The volume of the fluid flowing through the slots before a seal is formed is a direct measure of how fast a sealing fluid can form a seal. In a preferred embodiment, the sealing fluid in the lab test is the same as the drilling fluid.

The mud loss flow paths such as a wellbore fracture are often of a different geometry from these tiny pores defined in a ceramic disk or filter paper which simulates pores of rock formations as recommended in the API RP 13B-1, 13B-2 and 13I. Sealing a pore requires that at least some of the particles have a size at least ⅓ of the diameter of the pore due to the bridging effect of the particles. However, when sealing a fracture, some of the particles have to be at least the same size or larger than the fracture width. It is obvious that a sealing formulation for a fracture of a certain width can also seal a pore of a smaller diameter than the fracture width. But a sealing formulation that can seal a pore of a certain diameter may not be able to seal a fracture of a width the same as the diameter of the pore. So evaluating a sealing formulation for sealing a fracture is a tougher test. A fracture entrance at a wellbore is normally a long but narrow gap that can be simulated by a rectangle slot in a steel plate or disk. In US Patent Application 2013/0143777 A1, Wang describes a method of evaluating a particulate sealing formulation. US Patent Application 2013/0143777 is hereby incorporated by reference herein in its entirety.

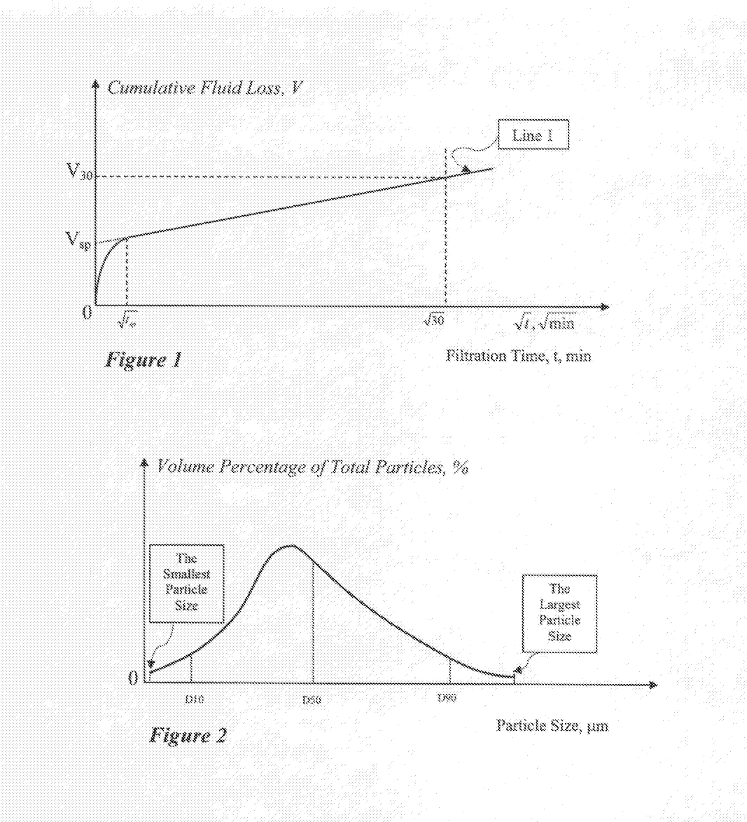

A steel slot disk is used as the filtration medium. Filter paper is not good enough for directly evaluating a particulate sealing formulation of a wellbore fracture. Filter paper has only tiny pores that can even let regular drilling mud form a filter cake on the paper. However, regular drilling mud without sealing particulates normally can completely flow through a slot in a steel disk, even when the slot width is only 200 micron. Porous ceramic disks can only be used to simulate something like sealing porous sandstone matrix and they are not suitable for evaluating sealing a fracture either. Though with a slot disk as the filtration medium, the fluid loss behavior for testing a sealing formulation is similar to the plot shown in FIG. 1. In one embodiment of this disclosure, the spurt loss obtained from such a test is a clear indicator for how fast a seal is formed. In an embodiment of the present invention, a particulate sealing formulation is evaluated by using a method described by Wang in US Patent Application 2013/0143777 A1. US Patent Application 2013/0143777 is incorporated by reference herein in its entirety.

The test slot should not have the slot width larger than the largest particle size. In one embodiment, the slot width is equal to a particle size between D50 and D100. In one embodiment, the slot width is 200 microns. In another embodiment, the slot width is 350 microns. In an exemplary embodiment, the slot width is 650 microns. In one embodiment, the slot width is substantially equivalent to the particle size at D90 in the particulate formulation. In another embodiment, the slot width is substantially equivalent to the particle size at from D99 to D70 in the particulate formulation.

Because a longer slot length will allow more fluid flowing through a slot before a seal forms, to compare the sealing performance for the same slot width, the spurt loss has to be converted to a unit slot length spurt loss such as ml/ft or milliliter per foot. In order to reduce the size of a test cell without compromising on accuracy, multiple slots can be put on a single disk with a known total length of the slots. The spurt loss then can be easily calculated by dividing the measured spurt loss volume by the total length of the slots. In one embodiment, the slot disk has 10 slots with a total length of 2 feet. In another embodiment, the slot disk has a total length of slots greater than 0.25 foot.

Pressure differentials applied to the test generally make very little difference on the spurt loss if the pressure is not high enough to break the formed seal. The pressure differential for the tests normally is 100 psi or higher. In one embodiment, the pressure differential is 100 psi. In another embodiment, the pressure differential is 500 psi. In another embodiment, the pressure differential is 1000 psi. In another embodiment, the pressure differential is determined by a well condition.

Temperature applied to the test makes little difference on the spurt loss. The temperature for the tests normally is room temperature or higher. It can be the temperature at which the formulation is planned to be used. In one embodiment, the temperature is 75° F. In another embodiment, the temperature is 120° F. In one embodiment, the temperature is 200° F. In one embodiment, the temperature is 300° F. In another embodiment, the temperature is determined by a well condition.

A sealing fluid is formed by mixing a particulate sealing formulation in a fluid including drilling fluid. This demonstrates an advantage of the formulation subject of this disclosure, i.e., the sealing fluid can be further intermixed with the drilling fluid. Due to the fine particles contained in the typical drilling fluid (0.5 to 2.0 microns) it may be found advantageous to dilute the fluid. As discussed further below, the fine particles may interfere with the fluid loss after spurt (but not the spurt loss tested on a slot disk). It will be appreciated that the increased fluid loss after spurt is critical for fast formation of a high pressure resistant seal structure. Increased fluid loss after spurt accelerates the quantity of particles brought to the slot for further placement in the seal.

The sealing fluid containing the particulates can be tested for its sealing performance or efficiency and be pumped down hole to seal a fracture or other voids. A mixing fluid specifically in which the sealing particulates are mixed in order to conduct the spurt loss test can be called a testing fluid. As stated above, it is preferable that the testing fluid be the same as the mixing fluid. The testing fluid, as long as the particulates are properly suspended during the test, is not affecting much of the spurt loss. A mixing fluid that is used to mix the sealing formulation for pumping it down hole to seal a flow path is a carrying fluid. In one embodiment, a testing fluid or a carrying fluid comprises of water, brine, oil, synthetic oil, diesel, polymer solution, sea water, drilling fluid, cement slurry, cement spacer fluid, completion fluid, oil based drilling fluid, water based drilling fluid, synthetic drilling fluid, salt saturated water. The testing fluid can be the same as a carrying fluid. In one embodiment, a carrying fluid is the same as a testing fluid. The testing fluid can be a fluid different from a carrying fluid. A testing fluid can be used for determining the spurt loss of a sealing formulation but it may not also be used as a carrying fluid later. In another embodiment, the testing fluid is a fluid different from a carrying fluid to be used. Biopolymer or hydroxyethylcellulose can be further added to the water for suspending capability. Clay or organoclay can also be added to a test fluid to provide suspending capability.

The smaller the spurt loss, the faster the sealing. A fast sealing fluid is preferred to have a spurt loss tested on the slot disk as small as possible. In one embodiment, the spurt loss of a fast sealing fluid required is no larger than 150 ml/ft. In another embodiment, the spurt loss of a fast sealing fluid required is no larger than 100 ml/ft. In one embodiment, the spurt loss of a fast sealing fluid required is no larger than 50 ml/ft. In one embodiment, the spurt loss of a fast sealing fluid required is no larger than 20 ml/ft. In one embodiment, the spurt loss of a fast sealing fluid required is no larger than 10 ml/ft. When a particulate sealing fluid has a spurt loss smaller than a required value as needed, it is a fast sealing fluid.

It has been discovered by experiment that the spurt loss is largely affected by the particulates that have a size above D30 of the total particle size distribution. Adjusting other smaller particulates is not necessary. With the spurt loss tests, a formulation can be optimized by adding more or removing some of a portion of the particulates larger than D30. This can be achieved by changing the total volume of particulates in one or more of the multiple groups. A group of the particulates can be a type of particulates or size fraction of particulates defined by two mesh sizes. For example, a group of particulates are a walnut hall between 20 and 50 mesh. Another group of particulates are calcium carbonate between 80 and 120 mesh. Another group of particulates are a mixture of particulates between 20 and 40 mesh. The trial-and-error method can be used to achieve a lower spurt loss formulation. When adding more of a group of particulates causing the spurt loss value to increase, the next step can be to decrease the amount of the particulates in order to see a smaller spurt loss. In order to achieve a target low spurt loss value, based on the tests, in one embodiment, a low spurt loss value (ml/ft) is achieved by systematically increasing or decreasing particulates in one or more groups that are larger than D30. In one embodiment, at least some of the groups of particulates larger than D30 are adjusted in concentration relative to those particulates smaller than D30.

For the same sealing formulation, a higher concentration of particulates in the sealing fluid tends to form a seal sooner or to generate a smaller spurt loss. In order to compare the sealing performance, the same selected concentration is required. A typical sealing formulation concentration is from 5 pounds per barrel to 120 pounds per barrel of the total sealing fluid. In one embodiment, the concentration of the particulates in the carrying fluid for the tests is 20 pounds per barrel (ppb) of the formed test fluid, which includes the added particulates. As used herein, a barrel is defined as a 42 gallon barrel. In another embodiment, the concentration of the particulates in the carrying fluid for the tests is 35 pounds per barrel (42 gallon barrel) of the formed test fluid, which includes the added particulates.

In one embodiment of the disclosure, the formulation is adjusted by changing the fractions of particulates that are larger than 200 micron e.g. the percentage of the added particulates larger 200 microns in a formulation at a concentration, for example, 35 pounds per barrel.

With the lab test, the sealing particulates in a particulate sealing formulation at the same concentration, e.g. 35 pounds per barrel, can be optimized by adjusting fractions of the particulates (D50, D70, D90, etc.) toward a minimal spurt loss value to improve the sealing efficiency. However, fast sealing or a low spurt loss value can also be achieved by increasing the concentration of entire sealing particulate formulation in a sealing fluid, e.g., increasing concentration from 35 pounds per barrel to 50 pounds per barrel. In one embodiment, the spurt loss value is reduced by increasing the concentration of the sealing fluid. In an embodiment, a fast sealing formulation has increased by 5 pounds sealing particulates in one barrel of the total sealing fluid. In an embodiment, a fast sealing formulation has increased from 20 to 35 pounds sealing particulates in one barrel of the total sealing fluid. It is preferred a sealing formulation is first optimized for fast sealing at a concentration then its concentration is further increased for the faster sealing to meet a requirement.

In cases, the mud loss flow paths may also be the channels for flowing hydrocarbon after completion of the well. In these cases, the formed seal is preferred to be acid removable. The commonly used acid is hydrochloric acid. With the small particulates as acid soluble, the formed seal can become highly permeable after the small particulates are dissolved by acid and removed from the seal. Furthermore, with the removal of the small particulates, the large ones are easily disrupted and removed by flowing back. Calcium Carbonate, Magnesium Carbonate, Magnesium Oxide and ground marble are acid soluble materials. In one embodiment, at least 5% by total volume of the sealing particulates are smaller than 200 micron and acid soluble. In one embodiment, at least 75% by total volume of the sealing particulates are acid soluble. In another embodiment, the acid soluble particulates are sized with one or more of calcium carbonate, Magnesium Carbonate, Magnesium Oxide, sea shell and ground marble. In another embodiment, the small acid soluble particulates are sized ground marble.

It seems intuitive that it would be always preferable that a particulate sealing formulation can seal off a fracture as fast as possible and as tightly as possible. However, when a formed seal is so tight that there is no further leakage through the seal, the seal will not have further accumulation of particulates. In other words, once a seal is formed tightly, it will not obtain further strength and will remain weak. In real drilling conditions, a formed seal may have to withstand a pressure differential that may be over several thousand pounds per square inch (psi). The formed seal is preferred to be strong for holding a high pressure differential. Conventional particulates used for sealing drilling fractures are such as calcium carbonate or walnut hulls are not very strong. Once a seal has formed without further leakage, the seal may have only one layer of particulates and it cannot be strong. A conventional particulate sealing formulation often forms a very weak seal, especially when it seals a fracture quickly without much further leakage. In reality, a particulate sealing formulation is often mixed in drilling fluid, which is normally designed to have a tight fluid loss control over small pores. When drilling fluid is used as a carrying fluid, the sealing formulation may form a seal even tighter allowing little further accumulation of particulates. Even when a seal is not perfect, the leakage can be very small without proper control and it can require many hours or days to have enough accumulation of particulates for enough strength. Rig waiting time is normally expensive and waiting for hours or days for the seal to grow strong is normally impractical. Furthermore, during treating a loss zone with a particulate sealing formulation, there is no easy way to know if a seal gets strong enough before a pressure test. However, the pressure test can be destructive and tends to break the seal and fail the treatment if the seal does not achieve adequate test strength. It is therefore preferred that a seal can be strengthened fast.

### II. A Fast Strengthening Particulate Formulation

Fast strengthening can be achieved by fast accumulation of many particulates onto the initially formed seal structure. The fast accumulation can be achieved by fast filtration through the initially formed seal. It is therefore preferable that the initially formed seal structure is still permeable or has controlled leakage to the carrying fluid of the formulation to allow further accumulation of more particulates on the initially formed seal. The controlled leakage here means that only the carrying fluid is allowed to pass through the formed seal and majority of the particulates in the formulation cannot pass the seal structure and are deposited there onto the seal structure continuously.

A fast strengthening formulation can be achieved with one or more of many different types of particulate materials. In one embodiment, the fast strengthening particulates selected for the sealing formulation comprise of one or more of the following materials: calcium carbonate, sand, coke, petroleum coke, graphite, resilient graphitic carbon, synthetic graphite, diatomaceous earth, cedar fiber, nut hulls, corn cobs, asphalt, gilsonite, rubber, drilled cuttings, saw dust, mica, wood chips, engineering plastics, fly ash, cotton seed hulls, walnut hulls, pistachio hulls, almond hulls, peanut hulls, cement, clay, bentonite, modified clay, organoclay, limestone, lime, magnesium carbonate, magnesium oxide, cement, concrete, dolomite, marble, sea shell, resin particles, metal particles, ceramic particles, weighting materials such as barite, hematite, iron oxide, ilmenite, and combinations thereof. Optionally, nanotechnology particles, e.g., silica nanoparticles, clay nanoparticles, and the like are used for the compositions. Optionally, chemically treated particles are used for the compositions. The chemically treated particles can include resin coated, surface sticky, surface hydrophobic and surface hydrophilic particles.

A fluid is needed to mix the fast strengthening sealing particulates into slurry so that the particulates can be pumped down hole to a loss zone to seal off a fracture or similar structure. The fluid can be any kind of oilfield fluids. In one embodiment, the fluid is one of the following liquid including water, brine, oil, synthetic oil, diesel, polymer solution, sea water, salt water, salt saturated water. In another embodiment, the fluid is one of the following fine-solid-containing fluids including drilling fluid, cement slurry, cement spacer fluid, workover fluid, completion fluid, oil based drilling fluid, water based drilling fluid, synthetic drilling fluid. These fine-solid-containing fluids may typically contain tiny insoluble solids of up to approximately 75 microns suspended in a liquid phase.

1. A Fast Strengthening Particulate Formulation to be Mixed with a Liquid

When the carrying fluid is water or oil rather than mud, the initially formed seal can be highly permeable only to the liquid. Particles are not supposed to pass through the initially formed seal. It has been discovered that the controlled leakage of the formed seal is best by changing the particulates smaller than D30. This is different from what is preferred for forming an initial seal. For forming an initial seal, particulates smaller than D30 in a formulation is much less important. In one embodiment, a plurality of porous and permeable particles can be included in the particulate sealing formulation by replacing all or some of the particulates in the particulate sealing formulation smaller than D30. More effectively, adding a plurality of porous and permeable particles to the existing fast sealing formulation as in one embodiment. In this case, the added plurality of porous and permeable particles are not counted as part of the particles smaller than D30. Alternatively, a plurality of porous and permeable particles are replacing a portion or all of the particulates that are smaller than D30 in a typical embodiment. The plurality of porous and permeable particles include diatomaceous earth particles or powder. In another embodiment of the sealing formulation, this is achieved by adding a plurality of diatomaceous earth to the particulate fast sealing formulation.

Diatomaceous earth is a naturally occurring, soft, siliceous sedimentary rock that is easily crumbled into a fine white to off-white powder. This powder is very light as a result of its high porosity. Diatomaceous earth consists of fossilized remains of diatoms, a type of hard-shelled algae. Many of diatomaceous earth particles have many tiny holes permitting liquid to pass through easily. Therefore it is often used as a filtration aid.

Diatomaceous earth powder can be a permeability adjuster for the formed seal to allow further accumulation of particulates after the initial seal formation. Lab tests have indicated that adding diatomaceous earth powder to a particulate sealing formulation can substantially increase the fluid loss rate of the sealing formulation or the permeability of a formed seal. A high fluid loss rate means a high flow rate of the liquid of the carrying fluid through a formed seal and this would promote a fast accumulation of more sealing particulates to the formed seal, i.e. fast strengthening of the formed seal.

In one embodiment, in the above mentioned particulate fast sealing formulation, diatomaceous earth powder is further included. Only small particles of diatomaceous earth are needed. These small particles are basically smaller than D30 of the fast sealing particulate formulation. In one embodiment, the average particle size of the diatomaceous earth powder is below D30 of the initial fast sealing particulate formulation. In one embodiment, the average particle size of the diatomaceous earth powder is less than 100 microns. In one embodiment, the particle size of the diatomaceous earth powder is from 10 micron to 300 microns. In another embodiment, the average particle size of the diatomaceous earth powder is from 25 to 150 microns. In another embodiment, the average particle size of the diatomaceous earth powder is from 25 to 75 microns. In another embodiment, at least 80% of the particle size of the diatomaceous earth powder is smaller than 250 microns.

The added diatomaceous earth powder particles can replace those solid particulates having the similar size in the initial fast sealing formulation. In one embodiment, 100% of the particulates in the initial fast sealing formulation and having a size similar to the diatomaceous earth powder to be added are replaced. In another embodiment, 0% of the particulates in the initial fast sealing formulation and having a size similar to the diatomaceous earth powder to be added are replaced. In this embodiment, the added diatomaceous earth powder is just simply added to the initial formulation. In another embodiment, 25.5% of the particulates in the initial fast sealing formulation and having a size similar to the diatomaceous earth powder to be added are replaced.

The more diatomaceous earth powder added, the faster the leakage through the formed seal. In one embodiment, 3% of diatomaceous earth powder by weight of the total particulate formulation is included in the formulation. In another embodiment, at least 1% of diatomaceous earth powder by weight of the total particulate formulation is included in the formulation. In another embodiment, 10% of diatomaceous earth powder by weight of the total particulate formulation is included in the formulation. In another embodiment, 45% of diatomaceous earth powder by weight of the total particulate formulation is included in the formulation. In another embodiment, the diatomaceous earth powder in the sealing fluid has a weight ranging from 1 ppb to 50 ppb.

Fast strengthening of a sealing fluid can be evaluated by an API filtration test as specified by API RP 13B-1 and B-2 by measuring the fluid loss against a filter paper or a porous ceramic disk.

Due to the fast filtration desired, it is normal to measure how long it takes for all the liquid in the sealing fluid in a test cell to be displaced out of the cell. A faster filtration rate means less time to displace all liquid out of the cell. So less time is preferred.

2. A Fast Strengthening Particulate Formulation to be Mixed with a Fine-Solid-Containing Fluid

It is desirable to have a lost circulation formulation that can allow its particulates to accumulate fast by filtration even in a fine-solid-containing fluid such as drilling fluid so that the needed filtration will not be affected by such as mud contamination. However, when fast filtration or a high permeability to drilling mud is allowed, the formed seal structure by filtration is still not tight enough and cannot stop lost circulation alone. This dilemma is solved by two steps: (1) form such a loose seal structure that is highly permeable to a fine-solid-containing fluid first; and then (2) reduce substantially the permeability of the loose seal structure to the fine-solid-containing fluid.

In the following exemplary embodiments, drilling fluid is used as an example of the fine-solid containing fluid to demonstrate how to formulate such a fast strengthening formulation. Similarly when a different fine-solid-containing fluid is selected, follow the same steps, a suitable fast strengthening formulation can also be formulated and applied.

In order to achieve the fast filtration, it is necessary that the pore throat of a formed seal structure is large enough to allow majority of the particles in drilling fluid to pass through the pore throat freely. This can allow the seal structure to form fast even in drilling fluid. The particulates should have a size and shape to favor the pore throat size for drilling fluid particles to pass through. However, the shape of the particulates at micron levels is difficult to control. Therefore, the size of the particulates is more important to ensure the seal structure is loose enough for drilling fluid.

Preferably the majority of the particulates for forming a loose seal structure have an average size at least two to three times of the average particle size of the majority of particles for drilling fluid which is a typical a fine-solid-containing fluid.

Therefore, considering regular mud may have an average particle size of 25 micron, the majority of the particles in a particulate formulation for fast filtration in mud should have an average particle size greater than 75 micron and this is approximately equivalent to US 200 mesh. In one embodiment, a particulate sealing formulation for fast strengthening in mud has a D75 above US 200 mesh or 75 micron. In one embodiment, a particulate sealing formulation for fast strengthening in mud has a D75 above US 100 mesh or 150 micron. In another embodiment, a particulate sealing formulation for fast strengthening in mud has a D75 above US 60 mesh or 250 micron.

When the particulates are of the same size, the seal structure tends to have the highest permeability. Though it is not necessary, it is preferable that the majority of the particulates have a narrow particle size distribution. So in one embodiment, a particulate sealing formulation for fast filtration in mud has at least 70% of its particle sized (particle size distribution) within 0.75 to 1.25 of its D50. For example, if the D50 of the formulation is 500 micron, at least 70% of the particulates fall in between 375 micron and 625 micron. As stated above, this narrow distribution achieves the highest permeability.

Such a high mud loss formulation preferably is mixed with a fine-solid-containing fluid such as drilling fluid, cement slurry, cement spacer fluid, workover fluid, completion fluid, oil based drilling fluid, water based drilling fluid, synthetic drilling fluid. However, it can also be mixed with a liquid such as water or oil.

Fast strengthening of a sealing fluid can be evaluated by an API filtration test as specified by API RP 13I by measuring the mud loss against a porous ceramic disk of pores 120 microns or larger. The pore size of the disk should be selected such that the pores are not be plugged by the fast strengthening fluid and the pores do not allow majority of the particulates to go through the disk either. Due to the fast filtration desired, it is normal to measure how long it takes for all the mixing fluid or mud in the sealing fluid in a test cell to be displaced out of the cell. A faster filtration rate means less time to displace all liquid out of the cell. In one embodiment, a test cell of 500 ml loses all its mixing mud within 3 min by the standard API test. In another embodiment, a test cell of 500 ml loses all its mixing mud within 5 min by the standard API test.

After a loose seal structure has formed in the mud loss flow path such as a fracture, the loss rate should be reduced since the mud now is flowing through a particulate pack structure rather than an open fracture. However, such a seal structure is apparently loose and it is not good enough to totally stop lost circulation. Another step to substantially reduce its permeability to drilling fluid is necessary to totally stop the lost circulation.

So in one embodiment of this invention, after the loose seal structure is formed, a pore sealing fluid to seal the formed loose seal structure is applied to seal off the pores or the openings of the structure exposed to the wellbore.

This pore sealing fluid is a particulate formulation of a wide particle size distribution from 0.5 microns to 1000 microns designed to quickly form a tight seal on the surface of the loose seal structure. This pore sealing fluid is a fast sealing particulate formulation demonstrated in at least one of the embodiments in disclosed in “I. A Fast Sealing Particulate Formulation” described above. This pore sealing fluid preferably is mixed in drilling fluid.

Alternatively, the pore sealing fluid is a settable fluid that can penetrate the loose seal structure and then set in the structure to seal off the structure.

The settable fluid includes but not limited to cement slurry, epoxy, crosslinking polyacrylamide, etc.

Alternatively, at least some of the particulates selected to form the loose seal structure are highly compressible or deformable. After a pressure differential of as low as 50 psi is applied to the loose structure, the structure then is compressed to reduce its pore size and therefore substantially reduce its permeability to drilling fluid.

Materials highly compressible or deformable include rubber, ground rubber, ground tire, wood saw dust, plastic saw dust, fiber, shredded rag, curly fiber, shredded foam, bended plastic film. In one embodiment of a particulate sealing formulation for fast filtration in mud, it comprises enough of highly compressible or deformable materials. In another embodiment of a particulate sealing formulation for fast filtration in mud, it comprises enough one or more of rubber, ground rubber, ground tire, wood saw dust, plastic saw dust, fiber, shredded rag, curly fiber, shredded foam, bended plastic film.

The concentration of particulate sealing formulation for fast filtration in mud is preferably from 10 pounds per barrel to 200 pounds per barrel.

The particulate sealing formulation for fast filtration in mud should be mixed in a mixing tank with agitators. Before mixing, drilling fluid or water or oil should be added to the tank. Then add the formulation to the tank through the hopper to be mixed.

During drilling, mix the particulate sealing formulation for fast filtration in mud with drilling fluid or a liquid such as water or oil, then pump it down hole to the lost circulation zone to form a loose seal structure in the mud loss flow path.

Then pump a sealing fluid downhole to the formed loose seal structure to seal off the pores of the structure. Alternatively, if the fast strengthening formulation forming the loose seal structure contains highly compressible or deformable materials, increase the wellbore pressure to substantially reduce the structure permeability.

3. A Fast Sealing Particulate Formulation Mixed in a Liquid also Strengthening Fast

An above fast sealing formulation mixed in a liquid can also be of fast strengthening. When tested against a filter paper or a porous ceramic disk, a fast sealing formulation also strengthening formulation will also have a spurt loss. This indicates how fast a first layer of fine particles deposited on the paper and this is largely affected by the concentration of the fine particles in the fluid. This has little to do with the fast strengthening and has to be removed for correct evaluation. In an embodiment of the invention, the evaluation of the fast strengthening effect is by measuring the spurt loss after spurt (or the total fluid loss less the spurt loss). The concentration of the sealing particulates in a typical range of a particulate sealing formulation such as 20 to 80 ppb has a limited effect on the fluid loss after spurt. Furthermore, fast strengthening is to be achieved after fast sealing has been achieved. So a fast sealing and fast strengthening sealing formulation has a minimum concentration defined first as a fast sealing formulation. This minimum concentration for a required low spurt loss makes the range for varying a particulate concentration much narrower. The test is normally done at a concentration from 20 to 80 ppb at room temperature under a 100 psi pressure differential. In one embodiment, the test is done at a concentration of 40 ppb at room temperature under a 100 psi pressure differential. A real downhole condition that tends to have a pressure differential higher than 100 psi may be more favorable for faster filtration.

The faster the controlled leakage, the faster the strengthening effect. Fast strengthening requires a fluid loss after spurt as large as possible. In one embodiment, the required fluid loss after spurt measured by API method is at least 10 ml. In another embodiment, the required fluid loss after spurt measured by API method is at least 20 ml. In another embodiment, the required fluid loss after spurt measured by API method is at least 50 ml. In another embodiment, the required fluid loss after spurt measured by API method is at least 100 ml.

Similarly, the fluid loss after spurt can also be measured with the slot disk. However, due to the much smaller filtration area, the fluid loss after spurt in 30 min of API test time would be much smaller and could be difficult to measure accurately. If this filtration medium is used, the fluid loss after spurt must be converted to a regular API value to be comparable. In one embodiment, the fluid loss after spurt is measured with a slot disk rather than filter paper. In another embodiment, the fluid loss after spurt measured with a slot disk is converted to a value for filter paper. In one embodiment, the fluid loss is measured with filter paper as the filtration medium. In another embodiment, the fluid loss is measured with a porous ceramic disk as the filtration medium.

With the fluid loss after spurt evaluation, a fast sealing formulation can be adjusted for its fast strengthening property by further modifying the formulation in order to meet a required fluid loss after spurt.

From a sealing formulation point of view, there are two major factors affecting fast strengthening: the seal permeability and viscosity of the carrying fluid. But most of the oilfield fluids for drilling have a similar viscosity. The seal permeability then is important for fast strengthening. It is most effective and convenient to adjust diatomaceous earth particles alone for higher seal permeability. In one embodiment, the concentration of diatomaceous earth particles increases from 5 pounds per barrel to 10 pounds per barrel. In one embodiment, the concentration of diatomaceous earth particles increases by 3 pounds per barrel. In another embodiment, the ratio of diatomaceous earth particles to other particulates increases from 3:97 to 7:93 when the total weight of the particulates in the carrying fluid is still the same.

The leakage through the formed seal can also be affected by the fine gaps between fine particles that are smaller than D30. If the fine particles smaller than D30 has a more uniform size, the permeability of the seal tends to be higher and strengthening then can be faster. If the fine particles smaller than D30 has a less uniform size, the permeability of the seal tends to be lower and strengthening then can be slower. In one embodiment, the particles smaller than D30 or smaller than 200 micron are adjusted toward a more uniform size to promote a high fluid loss after spurt for faster strengthening of the formed seal.

The finer the small particles of a particulate sealing formulation, the smaller the pores of the formed seal and the tighter the seal. In order to promote the leakage through the formed seal, in one embodiment, at least some of the particles smaller than 5 microns are removed. In another embodiment, all of the particles smaller than 5 microns are removed.

If the carrying fluid is a regular drilling fluid containing either clay or organoclay, together with the fluid loss control additive often added to drilling fluid, these types of particles can severely slow down the fast strengthening by plugging the small pores in the diatomaceous earth and other pores. It is advantageous to get rid of, totally or partially, the clay, organoclay and fluid loss additives from drilling fluid intended as a carrying fluid. Diluting the carrying fluid with the base liquid of the carrying fluid can substantially reduce the plugging effect and enhance the fluid loss after spurt. Furthermore, this dilution may reduce the viscosity of the carrying fluid to further promote the fluid loss after spurt. The base liquid can be water, seawater, salt water, salt saturated water, oil, diesel, mineral oil, synthetic oil or similar. In one embodiment, the carrying fluid which is a drilling fluid is diluted with one of the following: water, seawater, salt water, salt saturated water, oil, diesel, mineral oil, synthetic oil.

Flocculants can be further included in the fast sealing and fast strengthening particulate formulation to help to have a higher permeability of the formed seal structure for fast strengthening. In one embodiment, one or more flocculants are included in the formulation.

### 4. Suspending Capability of the Particulate Formulation of Fast Sealing and Fast Strengthening Mixed in a Liquid

In order to make sure the fast sealing and fast strengthening particulates are suspended in liquid, suspending agents may also be included. In one embodiment, a fast sealing and fast strengthening formulation further comprises one or more of the following suspending agents: attapulgite, sepiolite, biopolymer, hydroxyethylcellulose, clay and organoclay.

### III. A Particulate Formulation of Fast Sealing or a Fast Strengthening for Sealing Wide Fractures

Subterranean fractures or other mud loss flow paths can be much wider than half an inch. Limited by drill bit nozzles or other flow restrictions, particulates used for sealing fractures or other voids cannot be very large. With particulates of sizes up to only approximately 3000 microns can hardly seal larger fractures. In order to adapt the sealing of the particulate formulation to a large void such as a wide fracture, some flexible bridging materials can be further included. These large bridging materials are soft and they can be pumped through those flow restrictions with a size substantially larger than the flow restrictions. These large bridging materials are needed for forming a filtration bed at the entrance or inside a loss flow path such as a fracture so that the particulates can be filtered out on top of the bridging materials to form an accumulation of the particulates or a particulate seal. These bridging materials are preferred to be filtration materials, including sponge, foam rubber, open cell foam rubber, fiber, shredded rag, filter paper, straw, cotton, fiber pads and entangled fiber. These materials either have a plurality of cells allowing filtration or can form a mass that has such a plurality of cells allowing filtration. In one embodiment, the particulate sealing formulation further comprises of one or more of the following: sponge, foam rubber, open cell foam rubber, fiber, shredded rag, paper, straw, cotton, fiber pads, entangled fiber. Furthermore, when these flexible bridging materials are biodegradable, it is beneficial to the environment when the left-over is disposed of. Therefore, in one embodiment, the particulate sealing formulation further comprises of one or more of the following: biodegradable sponge, biodegradable foam rubber, biodegradable open cell foam rubber.

### IV. Application of the Particulate Sealing Formulations

When lost circulation has happened, at least one mud loss flow path has connected to the wellbore and a quantity of drilling fluid has charged the flow path or been lost into the flow path. When a flow path is an induced fracture, specially, the fracture width can be substantially widened by the charging drilling fluid and make it much more difficult to seal. It is sometimes preferable to seal mud loss flow paths while drilling the wellbore. In this case, the drilling fluid has to be modified for its sealing capability to become a treatment fluid. When drilling a wellbore with the treatment fluid, the treatment fluid will be circulated at all time and immediately contacting any new hole created by a drill bit. In this way, sealing may start when there is very little mud flowing into a loss flow path newly exposed. This is especially favorable for sealing induced fractures when they are still very narrow in fracture width with very little fluid charged into the fracture. When a well is drilled with continuous circulation of the treatment fluid, it is a continuous treatment. In one embodiment, the disclosed formulation of the fast sealing and fast strengthening particulates may be applied as a continuous treatment. As disclosed above, the procedure may be conducted with removal of fine suspended particles, replacement of particles with diatomaceous earth, and addition of fluid to lower viscosity.

However, not all lost circulation events can be prevented in such a way. Sometimes when a severe condition is encountered, the sealing capability from a mud cannot match it and lost circulation then will happen. Under such a condition, drilling has to be stopped and then a lost circulation material pill or a substantially smaller volume of a treatment fluid has to be pumped to cover the loss zone in order to seal the mud loss flow paths encountered. This may be done even when there have not been any mud losses. Normally in this case, a weak zone has been identified by a pressure test of the wellbore. A weak zone may lose drilling fluid when the wellbore pressure is increased later. Then the treatment fluid is pumped to the weak zone to seal the fractures under higher pressure to strengthen the wellbore. In either case, this is a discrete treatment. In one embodiment, the fast sealing and fast strengthening particulates of this disclosed formulation may be applied as a discrete treatment. In this manner, the disclosed formulation may be used as an LCM pill.

The formulations or mixtures of the disclosed sealing particulates can be achieved by blending at a location away from a drilling site where lost circulation may occur. In one embodiment, the blending is done at a factory, where one or more of the particulates are dry blended. In another embodiment, the blending is done at a rigsite, where one or more of the particulates are added into a carrying fluid in a mixing tank. As in one embodiment, adding various particulates proportionally into a blender to blend all the particulates into a mixture of a wide and continuous particle size distribution. Take a sample of the blended mixture of particulates, after mixing the sample with a testing fluid or carrying fluid, and measure the spurt loss of the fluid with the particulates. In another embodiment, adjust the sealing formulation of the particulates by such as adding more particulates larger than D30 incrementally until the spurt loss is small enough and acceptable. In another embodiment, increased concentration of the particulate sealing formulation may be performed incrementally until the spurt loss is small enough and acceptable. Furthermore, as in one embodiment, mix the particulates proportionally in a carrying fluid into slurry in a mixing tank at a rigsite. In one embodiment, measure the fluid loss after spurt of the slurry and ensure it is large enough and acceptable. If the fluid loss after spurt is not high enough, in one embodiment, dilute the carrying fluid with its base liquid such as water or diesel if carrying fluid is a drilling fluid or, in another embodiment, add more diatomaceous earth particles that are smaller than 200 microns or D30 of the initial sealing particulates. Repeat this until the fluid loss after spurt is large enough and acceptable. When needed, flexible materials can be further added. In one embodiment, after lost circulation has happened, pump a certain volume of the particulate slurry from the tank into drill pipe or tubing and then displace the volume of slurry down hole to the loss zone. In another embodiment, a weak formation is drilled through with continuous circulation of a sealing disclosed fluid.

This specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

1. A method of stopping lost circulation in a wellbore comprising:
a. formulating a sealing fluid comprising:
(1) selecting a particulate sealing formulation of a wide particle size distribution; and
(2) mixing the sealing particulates in a fluid to formulate a sealing fluid comprising a spurt loss of less than 150 ml/ft measured on a slot disk and a fluid loss after spurt greater than 10 ml; and
b. pumping the mixed sealing fluid into the wellbore.

2. The method of claim 1 further comprising one or more flocculants included in the particulate sealing formulation.

3. The method of claim 1, wherein the sealing particulates further comprises diatomaceous earth.

4. The method of claim 1, wherein the sealing fluid further comprises a testing fluid or a carrying fluid.

5. The method of claim 4, wherein the testing fluid or the carrying fluid comprising one of the following fluids including water, brine, oil, synthetic oil, diesel, polymer solution, sea water, salt water, salt saturated water, drilling fluid, cement slurry, cement spacer fluid, workover fluid, completion fluid, oil based drilling fluid, water based drilling fluid, synthetic drilling fluid or combinations thereof.

6. The method of claim 1, wherein the sealing particulates consist of one or more of the following materials: calcium carbonate, sand, coke, petroleum coke, graphite, resilient graphitic carbon, synthetic graphite, diatomaceous earth, cedar fiber, nut hulls, corn cobs, asphalt, gilsonite, rubber, drilled cuttings, saw dust, mica, wood chips, engineering plastics, fly ash, cotton seed hulls, walnut hulls, pistachio hulls, almond hulls, peanut hulls, cement, clay, bentonite, modified clay, organoclay, limestone, lime, cement, concrete, dolomite, marble, resin particles, metal particles, ceramic particles, weighting materials such as barite, hematite, iron oxide, ilmenite, nanotechnology particles such as silica nanoparticles, clay nanoparticles, chemically treated particles of these materials such as resin coated, surface sticky, surface hydrophobic and surface hydrophilic particles or combinations thereof.

7. The method of claim 3, wherein at least 90% by weight of the diatomaceous earth particles are smaller than 250 microns.

8. The method of claim 1, wherein the slot disk has a width opening equal to a sealing particle size in a range from D70 to D99.

9. The method of formulating a sealing fluid of claim 1, further comprising selecting a particulate from one or more of the following: sponge, foam rubber, open cell foam rubber, fiber, shredded rag, paper, straw, cotton, fiber pads, entangled fiber, biodegradable sponge, biodegradable foam rubber, biodegradable open cell foam rubber or combinations thereof.

10. The method of formulating a sealing fluid of claim 1, comprising selecting at least 5% sealing particulates by weight to be smaller than 200 microns and acid soluble.

11. The method of formulating the sealing fluid of claim 1, further comprising adjusting particulate size distribution larger than D30 to reduce spurt loss.

12. The method of formulating the sealing fluid of claim 1, comprising increasing the concentration of some or all particulates to reduce spurt loss.

13. The method of formulating the sealing fluid of claim 1, comprising diluting the particle concentration of a sealing fluid to increase the fluid loss after spurt.

14. The method of formulating the sealing fluid of claim 1, comprising increasing the size uniformity of particulates smaller than D30.

15. The method of formulating the sealing fluid of claim 1 comprising maximizing the fluid loss after spurt of the formulation by adjusting the size distribution of the formulation particulates smaller than D30 to a more uniform size.

16. The method of formulating the sealing fluid of claim 1 comprising maximizing the fluid loss after spurt of the formulation by adding diatomaceous earth.

17. The method of formulating the sealing fluid of claim 1 by selecting particle sizes to create a controlled leakage through a seal in the wellbore wherein the seal is comprised of particulates within the formulation.

18. The method of formulating the sealing fluid of claim 1, comprising suspending an agent of attapulgite, sepiolite, biopolymer, hydroxyethylcellulose, clay, organoclay or combinations thereof.

19. A method of stopping lost circulation in a wellbore comprising:
a. formulating a sealing fluid by mixing selected sealing particulates to form a particle size distribution in a fluid comprising:
(1) measuring a spurt loss on a slot disk of less than 150 ml/ft by adjusting at least the sealing particulates larger than D30 particle sizes;
(2) measuring a fluid loss after spurt adjusted by one or more of the following:
i. adding diatomaceous earth;
ii. increasing the uniformity of size of the particles smaller than D30 particle sizes;
iii. diluting the fluid;
iv. removing at least some particles smaller than 5 microns in the particulate formulation; or
v. including one or more flocculants.
b. pumping the sealing fluid into the wellbore.

20. The method of claim 19, selecting the fluid from water, brine, oil, synthetic oil, diesel, polymer solution, sea water, salt water, salt saturated water, drilling fluid, cement slurry, cement spacer fluid, workover fluid, completion fluid, oil based drilling fluid, water based drilling fluid, or synthetic drilling fluid.

21. The method of claim 19, comprising selecting the sealing particulates from one or more of the following materials: calcium carbonate, sand, coke, petroleum coke, graphite, resilient graphitic carbon, synthetic graphite, diatomaceous earth, cedar fiber, nut hulls, corn cobs, asphalt, gilsonite, rubber, drilled cuttings, saw dust, mica, wood chips, engineering plastics, fly ash, cotton seed hulls, walnut hulls, pistachio hulls, almond hulls, peanut hulls, cement, clay, bentonite, modified clay, organoclay, limestone, lime, cement, concrete, dolomite, marble, resin particles, metal particles, ceramic particles, weighting materials such as barite, hematite, iron oxide, ilmenite, nanotechnology particles such as silica nanoparticles, clay nanoparticles, chemically treated particles of these materials such as resin coated, surface sticky, surface hydrophobic and surface hydrophilic particles or combinations thereof.

22. The method of claim 19, comprising suspending an agent in the fluid including one or more of the following: attapulgite, sepiolite, biopolymer, hydroxyethylcellulose, clay and organoclay.

23. The method of claim 19, further comprising selecting a particulate from one or more of the following: sponge, foam rubber, open cell foam rubber, fiber, shredded rag, paper, straw, cotton, fiber pads, entangled fiber, biodegradable sponge, biodegradable foam rubber, biodegradable open cell foam rubber or combinations thereof.

24. A method of stopping lost circulation in a wellbore comprising:
a. formulating a fast strengthening particulate formulation;
b. mixing the fast strengthening particulate formulation in a fine-solid-containing fluid
c. pumping the fast strengthening particulate formulation and fluid into the wellbore to form a seal structure.

25. The method of stopping lost circulation in claim 24 further comprising formulating a fast strengthening particulate formulation by selecting particulates so that D75 of the particulate formulation is larger than 75 microns.

26. The method of stopping lost circulation in claim 24 further comprising formulating a fast strengthening particulate formulation by selecting particulates so that at least 70% of its particles are sized within 0.75 to 1.25 times of its D50 particle size.

27. The method of stopping lost circulation in claim 24 further comprising pumping a sealing fluid of a wide particle size distribution to seal the pores of the formed seal structure.

28. The method of stopping lost circulation in claim 24 further comprising increasing substantially the wellbore pressure to compress the formed seal structure to substantially reduce the formed seal structure permeability to the fine-solid-containing fluid.

29. A method of stopping lost circulation in a wellbore comprising:
a. formulating a sealing fluid comprising:
(1) multiple groups of particulates wherein each group comprises a narrow particle size distribution;
(2) the total particle volume of the particulates in each group ranges between 0.3 and 2.7 times of that particle size group's immediate next smaller or larger particle size group;
(3) mixing the sealing particulates in a fluid to formulate a sealing fluid; and
b. pumping the mixed sealing fluid into a wellbore.

30. The method of stopping lost circulation in claim 29 further comprising 75% by weight of the sealing particulates are acid soluble.

31. The method of stopping lost circulation in claim 29 further comprising a D50 particle size of each group falls in between 0.4 and 2.1 times of the D50 size of its next immediate smaller or larger group.

32. The method of stopping lost circulation in claim 29 further comprising each group of a narrow particle size distribution has 70% of the particles sized from 0.5 to 1.5 times the D50 particle size of the group.
